(19) United States
(12) Patent Application Publication
(10) Pub. No.: US 2013/0325410 A1
(43) Pub. Date: Dec. 5, 2013

(54) METHOD FOR REAL TIME ESTIMATION OF EMBODIED ENVIRONMENTAL IMPACT IN A BUILDING DESIGN

(71) Applicants: Uk Jung, Philadelphia, PA (US); Eric Jon Eisele, Aston, PA (US); Taylor Medlin, Philadelphia, PA (US); Billie Jo Faircloth, Philadelphia, PA (US); Stephen James Kieran, Moylan, PA (US); James Harrison Timberlake, Philadelphia, PA (US); Roderick Stewart Bates, Philadelphia, PA (US); Ryan Welch, Philadelphia, PA (US)

(72) Inventors: Uk Jung, Philadelphia, PA (US); Eric Jon Eisele, Aston, PA (US); Taylor Medlin, Philadelphia, PA (US); Billie Jo Faircloth, Philadelphia, PA (US); Stephen James Kieran, Moylan, PA (US); James Harrison Timberlake, Philadelphia, PA (US); Roderick Stewart Bates, Philadelphia, PA (US); Ryan Welch, Philadelphia, PA (US)

(73) Assignee: KIERANTIMBERLAKE ASSOCIATES, LLP, Philadelphia, PA (US)

(21) Appl. No.: 13/676,682

(22) Filed: Nov. 14, 2012

Related U.S. Application Data
(60) Provisional application No. 61/607,252, filed on Mar. 6, 2012.

(51) Int. Cl. G06F 17/50

(52) U.S. Cl. CPC G06F 17/5004
USPC 703/1

(57) ABSTRACT

A novel method for determining embodied environmental impact in a building design from a CAD model is disclosed. The method associates CAD model elements with data related to CAD modeling practice and material constants. The method recognizes and accounts for the fact that models alone rarely contain sufficient levels of detail to calculate material-based results such as embodied environmental impact or carbon content.

### CROSS-REFERENCE TO RELATED APPLICATIONS

This application is a non-provisional application of U.S. patent application Ser. No. 61/607,252, filed on Mar. 6, 2012, the entire application being incorporated by reference herein.

### FIELD OF THE INVENTION

The present invention generally relates to architecture and building design and specifically relates to a method of analyzing a CAD model to quantify total embodied environmental impact.

### BACKGROUND OF THE INVENTION

The construction of modern buildings utilizes a significant amount of natural resources, energy, and water. While architects have been designing for energy efficiency and resource reduction during operation of a building, few architects have been able to accurately quantify embodied environmental impact associated with building materials. For this purpose, embodied energy (i.e. kilojoule/kilogram material) and embodied carbon (i.e. kilogram CO2/kilogram building material) are the primary indicators of resource consumption during the raw material extraction, processing, manufacturing, finishing, transport, and fabrication stages of building materials.

Modern advances in Computer Aided Design (CAD) tools, including Building Information Modeling (BIM), facilitate the design of buildings by maintaining a volumetrically accurate representation of a building with material identifiers and component attributes which aid the architect in characterizing complex assemblies. Since the building model is volumetrically accurate and attributes can be assigned to parts at will, modern CAD tools are useful for generating and maintaining accurate take-off lists. Many tools have been developed in the prior art to generate such take-off lists for purposes such as cost estimation. Although a building model is dimensionally and volumetrically accurate, there are limitations, as explained below.

The architectural design process makes use of a building information model (BIM) to generate plans appropriate for the purposes of construction. Building information models are three dimensional representations of buildings rendered on the two dimensional frame of a screen, with all components dimensionally accurate, but scaled down considerably in detail to facilitate navigation and operate within hardware and software memory limitations. These models incorporate representations of many of the components of the building to be built, however they are not exhaustive. It is the function of a building model to incorporate sufficient information to allow for flexibility in design decisions and for a building to be accurately built in accordance with the design intent and specifications. To this end models are built with a level of detail that reflects both of these purposes. They do not incorporate every component to generate an exact digital facsimile of the real world building which would negate the design function, which requires flexibility sufficient to accommodate constant changes. Rather, for the purpose of facilitating design, hardware and software limitations, expediency, and associated costs, BIM models rely upon the knowledge of practitioners in the field of design and construction to incorporate many simplified representations of building components. This practice reduces the complexity of the models but requires interpretation on the part of all model users to ensure a building is accurately constructed:

The embodied environmental impacts of building materials may include, by way of example, global warming potential. Global warming potential is the carbon equivalent units emitted in the manufacturing of a particular good, which accounts for all carbon equivalent emissions up to the point of “factory gate”. This accounting of embodied environmental impact, by limiting scope to quantities such as global warming potential, differs from Life Cycle Analysis (LCA), which is a methodology that attempts to account for all environmental impacts of a given product beyond factory gate to include the point of material extraction, through manufacturing and product installation, operational life, and eventual end of life. In the field of architectural design and construction, a LCA, as a comprehensive process that is challenged by the scope of contemporary buildings and all the materials and systems they contain. The present invention facilitates the calculation of embodied environmental impacts up to “factory gate”, allowing any quantifiable metric used to determine embodied environmental impact during manufacture, such as embodied carbon, energy, water, and the like, to be considered within the broadest scope of the invention.

The embodied environmental impact of building materials is particularly important as it constitutes a significant portion of the complete environmental impact of a building throughout the entirety of its life. The resources used and pollutants emitted in the manufacture of various materials required to construct a building are a significant contributor to a building's complete impact profile. The calculation of the embodied environmental impact in building materials will become even more important as stringent energy codes lower building operations related environmental impact. As the energy required to manufacture materials varies greatly by material type, the material selection process undertaken by the architect is directly influential in the eventual embodied environmental impact for the building. An architect needs to quantify embodied environmental impact data during the building design process but the laborious process required for calculating embodied environmental impact prevents a timely provision of relevant information during the design process. Therefore, those skilled in the art often execute this type of analysis after the building design is completed.

Recent developments in the architectural field standardize the process of quantifying environmental impacts of a product or material and documenting these impacts in accordance with ISO standard ISO 14025. All references herein are incorporated by reference. ISO 14025 establishes principles for the declaration of environmental information through a document more commonly known as the Environmental Product Declaration, or EPD. An EPD includes energy and water usage data pertaining to the raw material extraction and subsequent processing and manufacture of an article, as well as information on emissions, the manufacturing process, ratio of non-renewable energy/renewable energy utilized in manufacture, and manufacturing waste, among other information. While the EPD includes highly detailed data on environmental impacts of individual objects or building materials, the standard suggests no method or practice of managing and computing this data throughout the building design process. Information contained in the EPD may be used as a source of material data for the invention described herein, however is generally not suitable for direct use within a CAD model.

Embodied environmental impact can be calculated during the architectural design process without specialized tools, however it requires calculating the volume of each material type contained within the building model, converting to mass via the materials density, and then calculating embodied environmental impact with the carbon, energy, and other data available for a given unit of the material. This process is laborious; particularly when the full multitude of materials found in a building is taken into account, and lends itself to inaccuracies and generalization due to the limitations discussed previously. The significant amount of time required for such an analysis results in embodied environmental impact calculations being conducted at the end of a project and not iteratively during the design phase. An analysis conducted after the completion of a design can only be used for the purpose of assessing the performance level achieved, not minimizing the embodied environmental impact in the design. For this reason the capacity to actively quantify embodied environmental impact during the design process, in manner that allows for the rapid comparison of the relative impact of material selection decisions in “real time”, is essential if environmental impacts are to be minimized.

United States Patents generally related to the field include: U.S. Pat. No. 6,343,285 (Tanaka et al.); U.S. Pat. No. 6,816,819 (Loveland); U.S. Pat. No. 7,130,775 (Takagaki et al.); U.S. Pat. No. 5,761,674 (Ito); U.S. Pat. No. 7,596,518 (Rappaport et al.); U.S. Pat. No. 6,493,679 (Rappaport et al.); U.S. Pat. No. 6,438,922 (De Le Fevre); U.S. Pat. No. 6,999,965 (Cesarotti et al.); U.S. Pat. No. 7,043,324 (Woehler); U.S. Pat. No. 7,013,246 (Gerlovin et al.); U.S. Pat. No. 7,747,483 (Puerini et al.); and U.S. Pat. No. 6,996,503 (Jung).

Thus, a real time embodied environmental impact tool is required to function within this context by recognizing and accounting for inherent representational aspects of CAD models while still delivering embodied environmental impact figures that reflect the actual components rendered in the CAD model if they were to be built. A novel tool to provide an architect with real time information on embodied environmental impact resulting from his or her design decisions would allow for active and informed decision making, as well as the opportunity for alternative material specification that allows for a lower embodied environmental impact.

### SUMMARY OF THE INVENTION

An embodiment of the invention is a method for determining embodied environmental impact in a building design from a model, the method includes the steps of generating in a computer-aided-design (CAD) program a building model having CAD model elements; providing reference data regarding physical elements; generating a first take-off list based on the building model; analyzing the first take-off list to find matches between the CAD model elements and the reference data; modifying the first take-off list based on the reference data; generating a second take-off list based on the first take-off list and the reference data; calculating embodied environmental impact from the second take-off list and the reference data.

In a further embodiment, at least one of the CAD model elements is not a fully detailed model in relation to the as built, physical element and reference data corresponding to the CAD model element includes details not included in the CAD model element. In a further embodiment, the reference data comprise information about a component including at least one of: material identifiers, embodied energy, density, embodied carbon, embodied water, synonymous names, and sources for material figures and calculations. In a further embodiment, the reference data include information about a component including at least one of: a material constant, a formula describing material utilization, and a quantification of materials inside an assembly. In a further embodiment, the reference data reside in a database and the database is updated whenever component information that is new or different component information than previously-stored component information is available. In a yet further embodiment, reference data from a database are combined with user-inputted data to generate take-off formulas. In this embodiment, the resulting take-off formulas are stored in the CAD model, in the database for use in other CAD models, or in an external data file.

In a further embodiment, the first take-off list includes component identifiers and take-off data. Take-off data comprise the geometric dimensions, volume, weight, or area of the CAD model elements. In a still further embodiment, the first take-off list further comprises take-off methods, which describe how a physical material is quantified geometrically with respect to an element within the CAD model and which specifically relate the types of data necessary for take-off formulas. In a further embodiment, the first take-off-list further comprises take-off formulas, which represent functional relationships between modeled geometry and a physical material quantity of a building component. In one embodiment, a take-off formula is generated based on stored information in the database; in another embodiment, the user generates the take-off formula by selecting a pre-defined take-off method and entering physical element specific data determined by the take-off formula.

In a further embodiment, the modification of the first take-off list is performed at the initiation of a user. In a further embodiment, the first take-off list is automatically generated each time the building model or component information changes. In a further embodiment, the reference data comprise formulas relating a quantity, area, length, volume or mass take-off to a material utilization constant.

In another embodiment, the first take-off list contains links between CAD model elements and the database as well as take-off methods and take-off formulas for the elements. In a further embodiment, the links between CAD model elements and the database are automatically generated based on user inputted identifiers such as material names. Each the material identifier may comprise a plurality of short, abbreviated, or common names stored in the database to aid in the rapid identification of elements. In a yet further embodiment, the user is prompted to select a take-off method from a list comprising a plurality of take-off methods. In a further embodiment, the take-off method is automatically selected based on the identifiers. In a further embodiment, the user is prompted to input at least one numerical constant relating the modeled CAD element to the built physical element. In this embodiment, the user selected take-off method determines the types of numerical constants needed. In a still further embodiment, the inputted numerical constants and the selected take-off method comprise data used to generate take-off formulas.

In another embodiment, the first take-off list exists within the CAD model as a database, and no distinct take-off list is generated. In this embodiment, the take-off methods, material identifiers, and take-off formulas are linked to the CAD model database. In a further embodiment, a separate database is used to store reference data, such as material constants, take-off methods, previously-generated take-off formulas, and take-off formulas from other distinct CAD models.

In another embodiment, the invention is a method for determining embodied environmental impact in a building design from a building model. The method includes the steps of: generating in a computer-aided-design program a building model having CAD model elements; providing reference data regarding physical elements; providing take-off formulas representing physical elements; generating a take-off list based on the building model; calculating embodied environmental impact from the take-off list and the reference data and the formulas. In a further embodiment, the take-off list is automatically generated when changes are made to the building model.

In another embodiment, the invention is a method for determining embodied environmental impact in a component element of a building model. The method includes the steps of: generating in a computer-aided-design program a representative geometry of the component element; choosing from a list of options a standard take-off method to apply a take-off formula based on user CAD modeling practice; providing reference data regarding physical elements; and calculating the embodied environmental impact based on the take-off data, the take-off formula, and the reference data. In a further embodiment, the CAD model element data comprise a quantification of elements in a model in the units of volume, mass, length, area, or part count. In a further embodiment, CAD model element geometry is generated to be homogenous in material, when actual physical element is non-homogeneous in material. In a further embodiment, the standard take-off formulas are relationships between embodied environmental impact quantities of elements, take-off data, and reference data. In a further embodiment, the take-off data comprise an area take-off, quantity, length, mass, or volume. In a further embodiment, the take-off formulas are stored in the take-off methods and displayed through a graphic user interface. In a further embodiment, the reference data comprise material descriptions, material constants, names, model numbers, bibliographic information, synonymous names, embodied energy quantity, embodied carbon, embodied water, or density.

### DESCRIPTION OF THE DRAWINGS

FIG. 1 illustrates a prior art material take-off and calculation process;

FIG. 2 illustrates an embodiment of a process for generating a first take-off list and then a second take-off list suitable for direct material calculation;

FIG. 3 illustrates an embodiment of a process for generating suitable data for direct material calculation from a CAD model;

FIG. 4 depicts a typical building model;

FIG. 5 illustrates a typical building assembly in which the computer modeled geometry differs from the built geometry;

FIG. 6 illustrates a typical take-off list; and

FIG. 7 illustrates a take-off list generated through a series of automated steps, which is suitable for direct material calculations;

FIG. 8 illustrates a graphic user interface through which the operator provides reference data and take-off methods to the model or database;

FIG. 9 illustrates a graphic user interface through which the user provides physical element data used to generate take-off formulas.

### DETAILED DESCRIPTION

Several embodiments of methods which translate a building model into a suitable take-off list for material classification in real time are disclosed. Take-off tools are generally used to gather input data in the form of a take-off list. The take-off list also includes identifiers for objects in the model, such as the material name or take-off metric, an identifier used to indicate how a material is applied spatially within the model. In one embodiment, the take-off metric is used to indicate whether a material is applied on an area basis or a volumetric basis. This distinction is useful when applying the method to building models containing coatings, thin sheet materials, and other layers modeled without thickness. Depending on the take-off metric, different standardized take-off formulas are used to gather and calculate data based on the physical element metrics. These take-off formulas may comprise correction factors. Other embodiments make use of the data provided in a take-off formula where an object must be quantified on a linear unit length basis, an instance-quantity basis, in a fashion where the quantity used by the installer changes conditionally, or where material yields are low, resulting in construction waste. In an embodiment, the take-off formula is applied as a novel correction in all situations where the actual quantity of a material in the resulting building differs from the computer modeled material.

In an embodiment, the operator is prompted for pieces of information, such as conditions under which a material or object is modeled, to generate a building model. This input, herein referred to as a take-off formula, is a material dependent relationship between a modeled geometry and a physical building material. In this embodiment, take-off formulas may be entered at any point in the design process, however the completeness of the data entered before performing a calculation corresponds to the resulting accuracy and error.

In this embodiment, the method uses a material database containing common construction materials and their associated embodied environmental impact quantities, synonymous names, bibliographic sources for material figures and calculations, and other material properties.

A material take-off list is generated from a computer building model. In addition to quantity, volume, and area quantities for objects, each object in the take-off list has a corresponding take-off method which describes how an object is represented in the building model. By way of example, one take-off method directs the method to find a suitable take-off formula for a floor coating which is applied to a thickness ‘x’ to an area ‘a’. In this example, the take-off list contains the area ‘a’ as well as a material descriptor, the take-off method indicates that the material is applied across a quantified area ‘a’, and the take-off formula contains the material thickness and other correction factors that account for material waste and other factors that impact material utilization. Once a quantifiable volume is calculated with the takeoff list, take-off method, and take-off formula, a database is polled for the material descriptor. The material descriptor corresponds to identifiers in an existing database which contains material properties, for example, embodied energy and density. When a database match is made, the embodied environmental impact for the object in the take-off list is calculated.

In another embodiment, the method calculates a percentage error for the takeoff data associated with each object in the CAD model. Additionally, the material database may contain percentage error for material constants due to inherent disagreement between various sources of embodied environmental impact data. In an embodiment, percentage error related to source material data is calculated for each CAD model element, and an aggregate percentage error is then calculated.

At least one synonymous name for a material is stored for each entry in the database. The database is then polled for a match among these aliases. This process is advantageous because the model material identifier from the take-off list may be one of many conventional names used for an object or material.

The sources of information used to acquire material figures, for example embodied energy, are stored in the database. This generally consists of bibliographic references. The operator may choose to generate a full report containing the full list of bibliographic sources which contributed raw data for the purpose of the calculation.

The database stored density, embodied energy per unit mass, embodied CO2 per unit mass, embodied water in manufacturing per unit mass, non-renewable embodied energy per unit mass, embodied energy of recycling per unit mass, recycled content per unit mass, embodied energy in transportation per unit mass, and other material properties of the like. The method is able to calculate, in real time, an aggregate figure for any of these material properties. The calculation of any quantifiable material property shall be considered within the scope of the invention.

The database stores environmental impact information related to materials and objects calculated according to accumulated material take-offs. This material inventory can include embodied energy, embodied carbon and embodied water per unit mass, as well as embodied energy, embodied carbon and embodied water broken down by life cycle stage (extraction, manufacturing, use and disposal). The database may also store embodied carbon and energy broken down by non-renewable fossil fuel, biomass, and nuclear energy types; and renewable biomass, hydroelectric, wind, solar, geothermal, and other types of energy. Additionally, the database can store and organize a number of midpoint impact measures including, global warming greenhouse gases (kilogram CO2 equivalent), ozone depleting gases (kilogram CFC 11 equivalent), photochemical oxidant creation potential (kilogram C2H4 equivalent), Aquatic Acidification (H+ moles equivalent or kg SO2 equivalent), Acidifying gases (kilogram SO2 equivalent), Terrestrial eutrophication substances (kilogram nitrate or phosphate equivalent .), Aquatic eutrophication substances (kilogram nitrate or phosphate equivalent), Human toxicity cancerous/non-cancerous for air, water, and soil (comparative toxicity unit), Ecotoxicity (comparative toxicity unit, CTUe), Smog (gram NOx equivalent.), Indoor air quality (kilogram total volatile organic compound, TVOC, equivalent.), Slag/ash creation (kilogram), Habitat alteration (threatened and endangered count, as described in NISTIR 7423), Carcinogenics (comparative toxicity unit), and respiratory impact substances (kilogram particulate matter 10, PM10, equivalent).

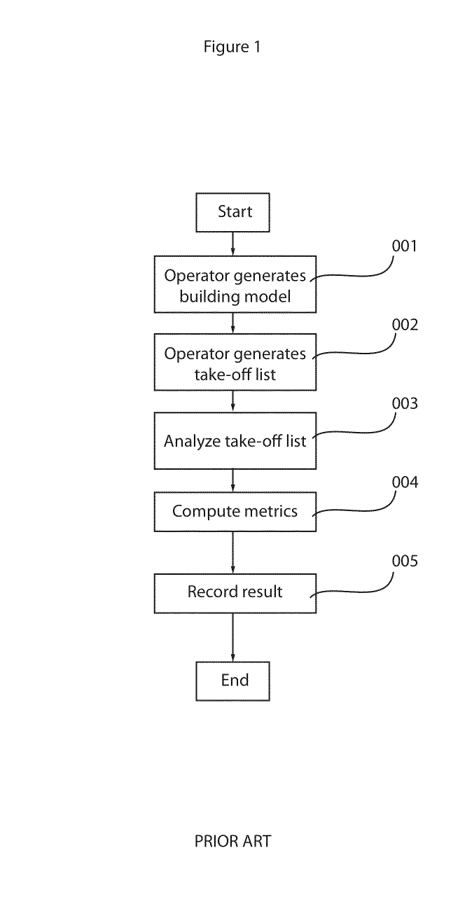

Material take-offs are generally used for cost estimation, tabulation of material utilization, quantification of embodied materials or energy, and the like. FIG. 1 illustrates the steps an operator would execute in order to calculate a material dependent figure, such as embodied energy, within a model. These steps generally comprise first generating a building model 001, generating a material take-off list 002, analyzing the take-off list for components, assemblies, and materials 003, computing metrics based on the analysis of the materials present 004, and recording or displaying the result 005. It should be noted that the steps 002, 003, 004, and 005 are generally executed by the user in a manual process. Due to the limitations of architectural models described earlier, namely that modeled geometries rarely match that which is actually built, the process described by FIG. 1 becomes quite laborious and rarely produces accurate results.

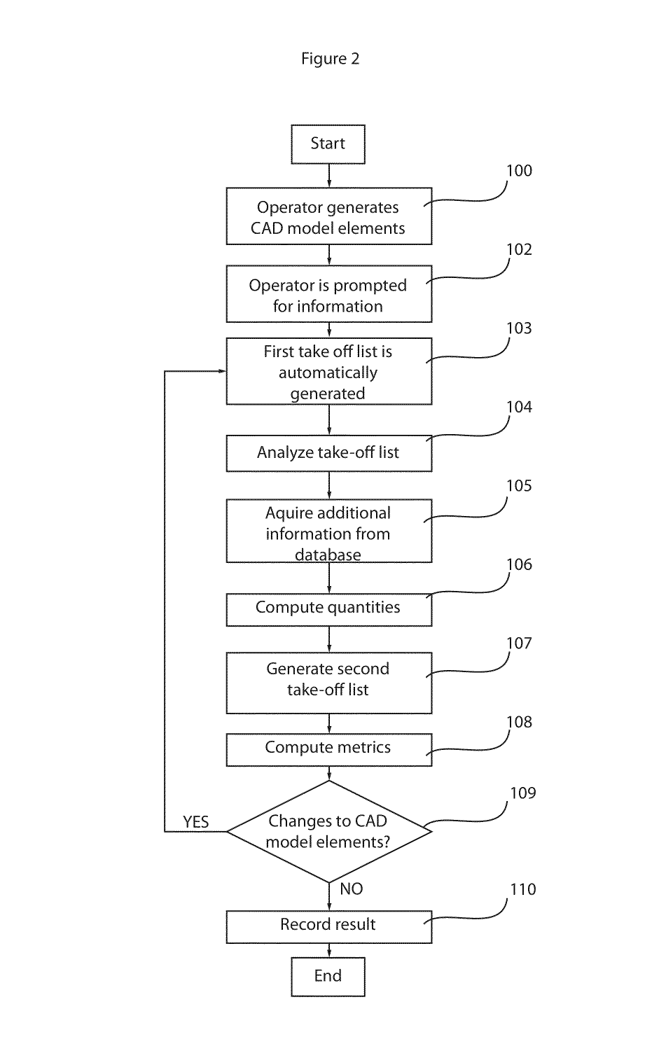

An embodiment of the present invention can generally be understood by the steps illustrated in FIG. 2. As previously described, the operator generates a building model 100 and enters other information related to the building 102. The other information can include material names and identifiers, take-off methods, and representation ratios. As changes are made to the building model that would impact a quantity on the material take-off, a real-time take-off list is generated 103 containing the materials, objects, and assemblies in the model along with their associated quantity, volume, area, representation ratio, and take-off method, among other information. This first take-off list is then analyzed 104, specifically to find matches between the material take-off list and the database. As matches are made between the database and the first take-off list, the appropriate corresponding information from the database is acquired and stored in memory 105. This information may include, but is not limited to, material constants, formulas describing material utilization, ratios of materials inside assemblies, and the like. Based on this information, appropriate quantities are calculated 106 and stored in a second take-off list that is generated 107. The second take-off list can then be used for direct material calculations 108 since it contains corrected quantities and instructions on how to calculate the required information. This information is generally recorded or displayed to the user 110. The method is able to update this information in real time if changes are made to the CAD model elements 109; the takeoff list 103 is updated and a new calculation is executed.

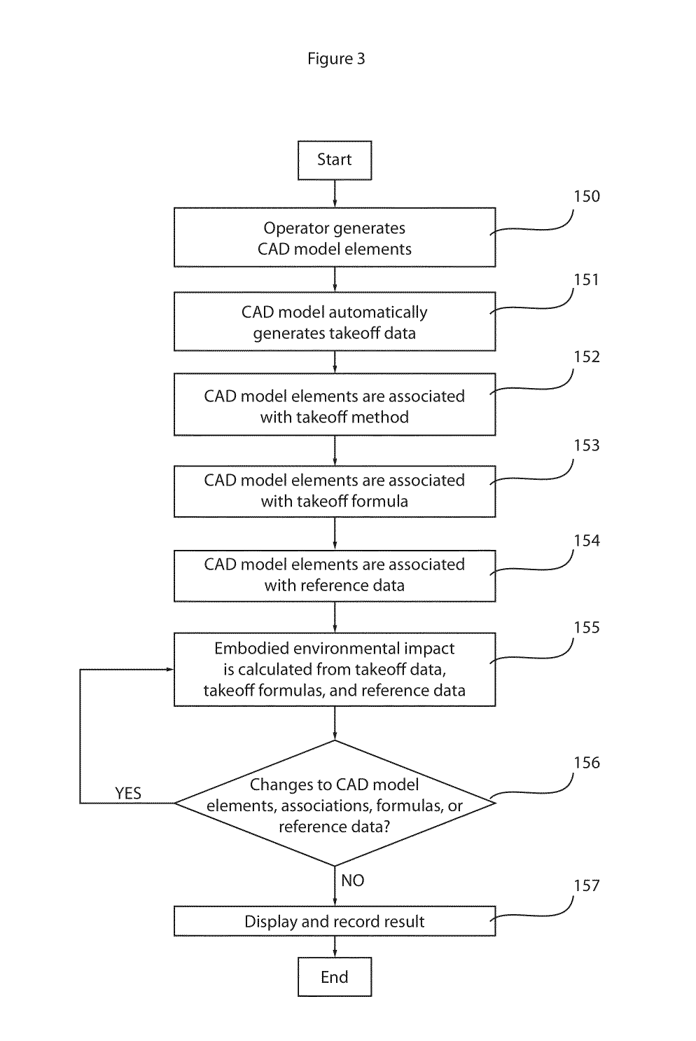

Another embodiment of the invention is illustrated by the steps in FIG. 3. The operator generates a building model containing CAD model elements 150, and the CAD model automatically generates take-off data 151 related to the CAD model elements. The CAD model elements are then associated 152 with a take-off method, which describe how a physical material is quantified geometrically with respect to an element within the CAD model and which specifically relate the types of data necessary for take-off formulas. The CAD model elements are further associated with a take-off formula 153, which is a material dependent relationship between a modeled geometry and a physical building material. The CAD model elements are further associated with reference data 154, which comprises material constants, densities, and environmental impact data such as embodied carbon and embodied energy. Total embodied environmental impact is then calculated 155 from the take-off data, the take-off formula, and the reference data. Calculation of total embodied environmental impact 155 occurs each time a change 156 is made to CAD model elements, each time 156 CAD model elements are added or removed, when the CAD model is opened or saved 156, at the direction of the operator, or upon changes 156 to the associations 152, 153, 154, changes to the reference data, or changes to take-off formulas. The step of associating 152, 153, 154 the CAD model elements with the take-off methods, the take-off formulas, and the take-off data may be automatic in some embodiments of the invention, may occur in distinct steps, or may occur in combinations of steps. In another embodiment, the operator may be prompted to associate 152, 153, 154 CAD model elements with the take-off methods, the take-off formulas, and the reference data. In a further embodiment of the invention, the calculated environmental impact result is stored 157 in a version history within the CAD model or displayed to the operator.

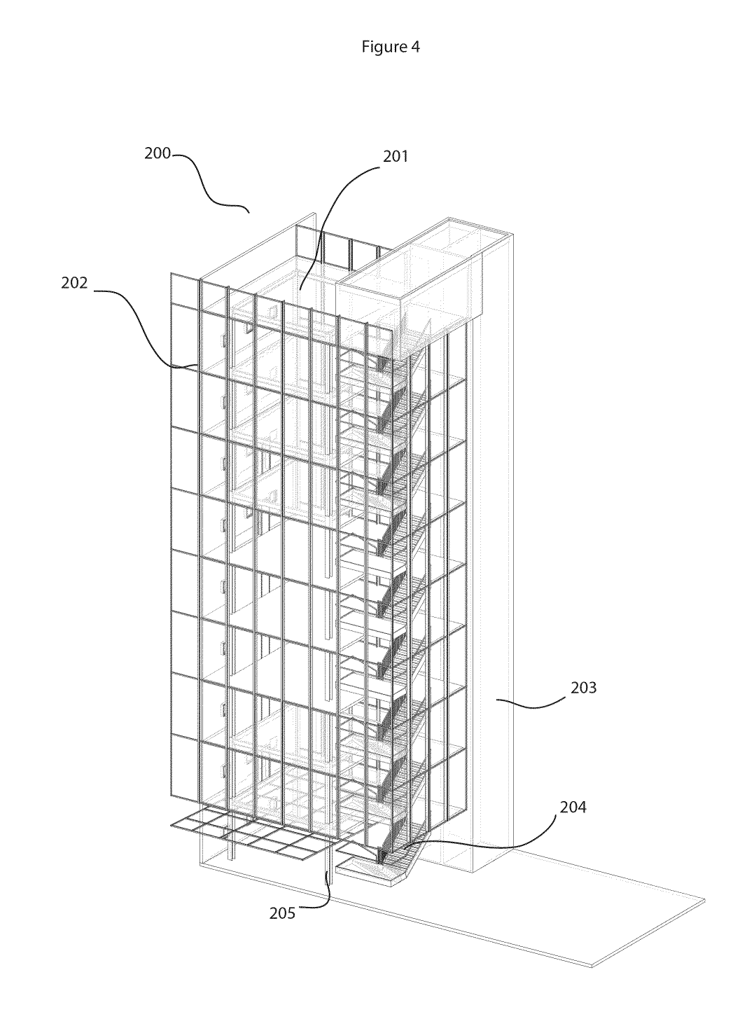

The present invention is generally applied to computer aided design (CAD) tools in which many complex assemblies and systems are present. FIG. 4 illustrates a typical building model 200 the present invention may operate on. Simple materials, such as structural steel 205 and concrete 203 are present in such models, however they may not be modeled to full detailing to include features such as voids, treatments, or coatings. Likewise, building systems such as glazing and curtain-wall assemblies 202 comprise many materials which are not represented in full detail due to model complexity and the phasing of addition of detail throughout the design process. While building models 200 may contain floor slabs 201, floor coatings are not modeled at all since this information is not relevant to the larger geometry and overall design at the scale of the building. Modeling a floor coating on a floor slab 201 is not considered standard practice, however including such features in required design documentation, cost estimates, embodied environmental impact calculations, and the like is critical. The present invention facilitates accurate quantification of that which is not present in conventional building models without hampering operator workflow. One skilled in the art will recognize that architects and designers can use shorthand modeling techniques to represent building components, and refer to this as CAD modeling practice.

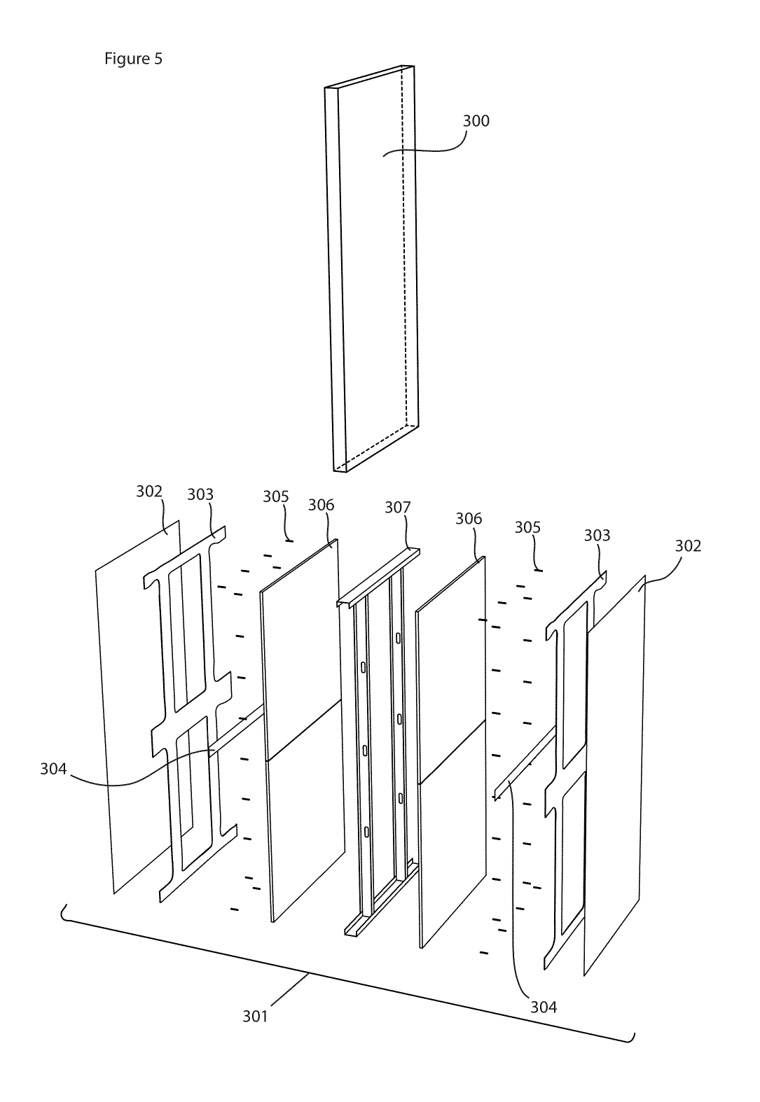

Further illustrating why a building geometry, as represented in computer aided design software, does not contain the required information for direct material quantification, FIG. 5 depicts two wall assemblies. The wall assembly 300, as drawn, is typical of the level of detail that may be present in a building model, while the wall assembly 301, as drawn, depicts the actual components interior paint 302, joint compound 303, joint tape 304, fasteners 305, gypsum wall board 306, and studs 307 within the wall assembly when built.

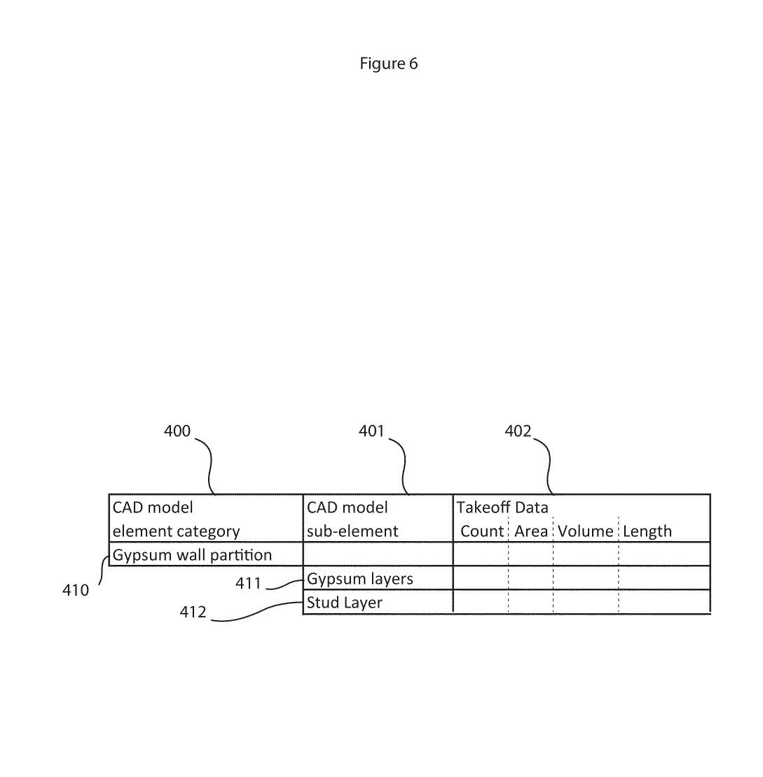

FIG. 6 illustrates a take-off list typically generated by computer aided design tools. In the preferred embodiment of the invention, the take-off list includes material or object names 400 as well as take-off data 402. Depending on CAD modeling practice, some CAD model elements 410 are classified as categories, families, groups, or parent objects, while other CAD model elements 411, 412 are classified as sub-elements. This practice delineates explicitly modeled components from assemblies made up of explicitly modeled components. Each type of object may be associated with different take-off data. Further, elements may be associated with an element identification number, which is a unique descriptor of the collection of instances of the element in the model or a unique instance the element.

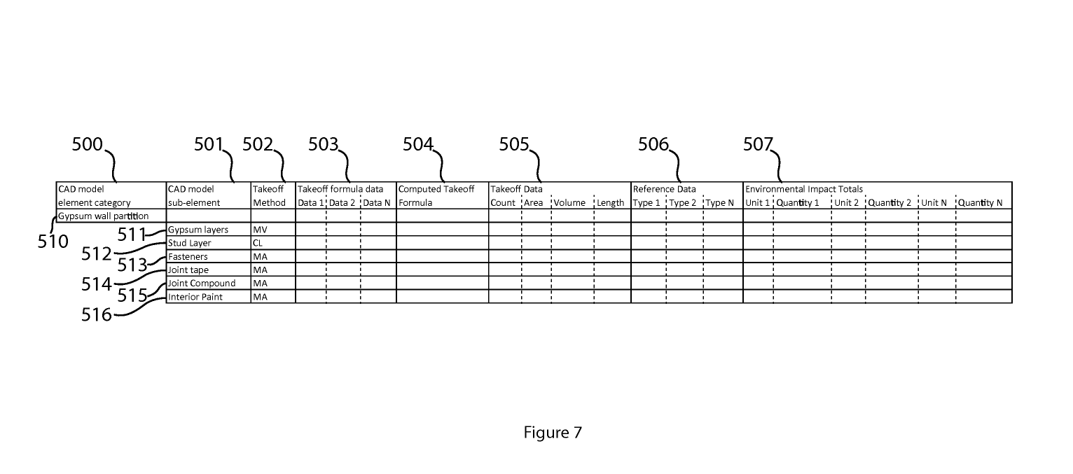

In an embodiment, data contained in the CAD model and data utilized by the invention may be represented as a single database for the purpose of illustrating the invention. In such an embodiment as illustrate in FIG. 7 the operator generates a CAD model containing CAD model elements 500, 501. The CAD model elements comprise explicitly modeled geometry 510 representing components which are not fully detailed in a higher level model 300. In another embodiment, some CAD model sub-elements 511, 512 are modeled and are associated with a CAD model element category 510, comprising an assembly. In the embodiments, CAD model elements gypsum wall partition 510, gypsum layers 511, and stud layer 512 are further associated with sub-elements that are not explicitly modeled including fasteners 513, joint tape 514, joint compound 515, and interior paint 516.

In a further embodiment, the CAD model elements gypsum layers 511, and stud layer 512 are further associated with sub-elements that are not explicitly modeled including fasteners 513, joint tape 514, joint compound 515, and interior paint 516 are further associated with a take-off method 502. In such embodiments, the take-off method is selected by the user from a list of standard take-off methods or is automatically matched based on previous modeling practice or CAD model element name 500, 501. The take-off method directs the method to apply different types of take-off formulas to the take-off data; by way of example, one take-off method directs the method to calculate embodied environmental impact based on modeled volume (MV). In this example, modifications to the modeled volume to account for non-modeled features such as voids or porosity are stored in the take-off formula 504, which often comprise a plurality of component data 503.

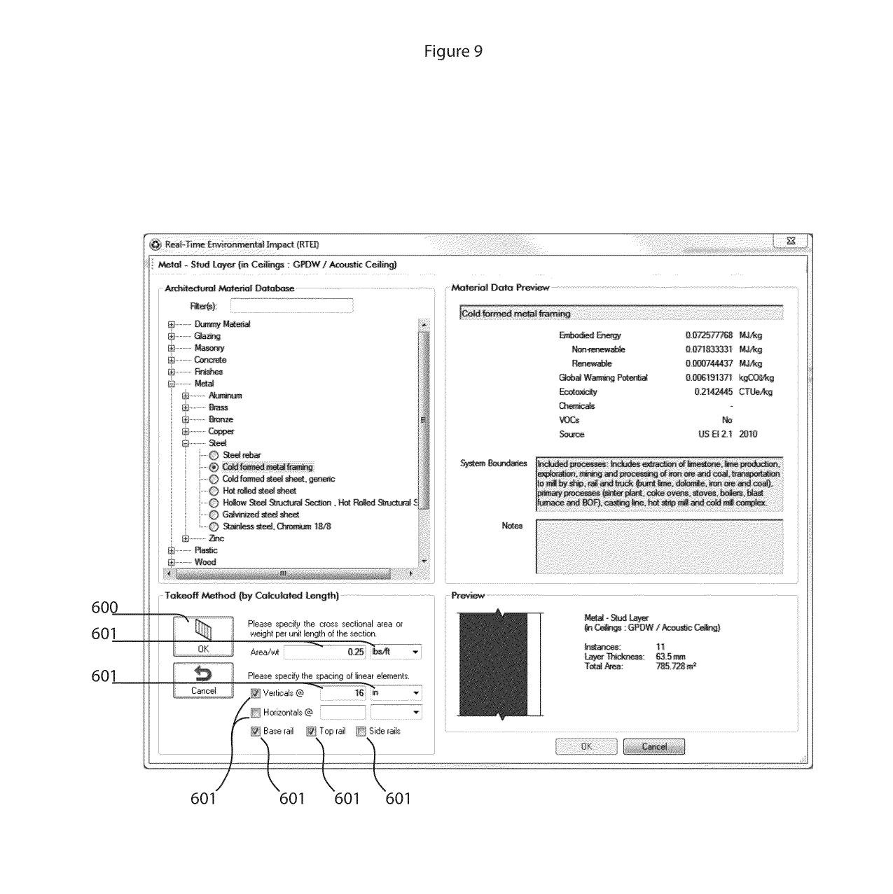

In a further embodiment, CAD model elements are associated with a take-off formula 504. The format for the take-off formula is determined by the associated take-off method, and may comprise a default relationship between modeled geometry and physical element. In another embodiment, the take-off formula may be a relationship stored in the reference database based on CAD modeling practice. In another embodiment, the method prompts the operator to define the take-off formula 504 based on component take-off formula data 503 through a graphic user interface (FIG. 9).

In a further embodiment, CAD model elements 500, 501 are associated with reference data 506 stored in an external reference database. In a further embodiment, the reference data 506 is automatically associated with CAD model elements based on CAD model element name 500, 501.

In an embodiment, the associations generated by the method are stored in the CAD model or in an external database for use on other CAD models. In a further embodiment, heuristic associations are made within a CAD model based on the stored associations in real time while the operator generates the CAD model.

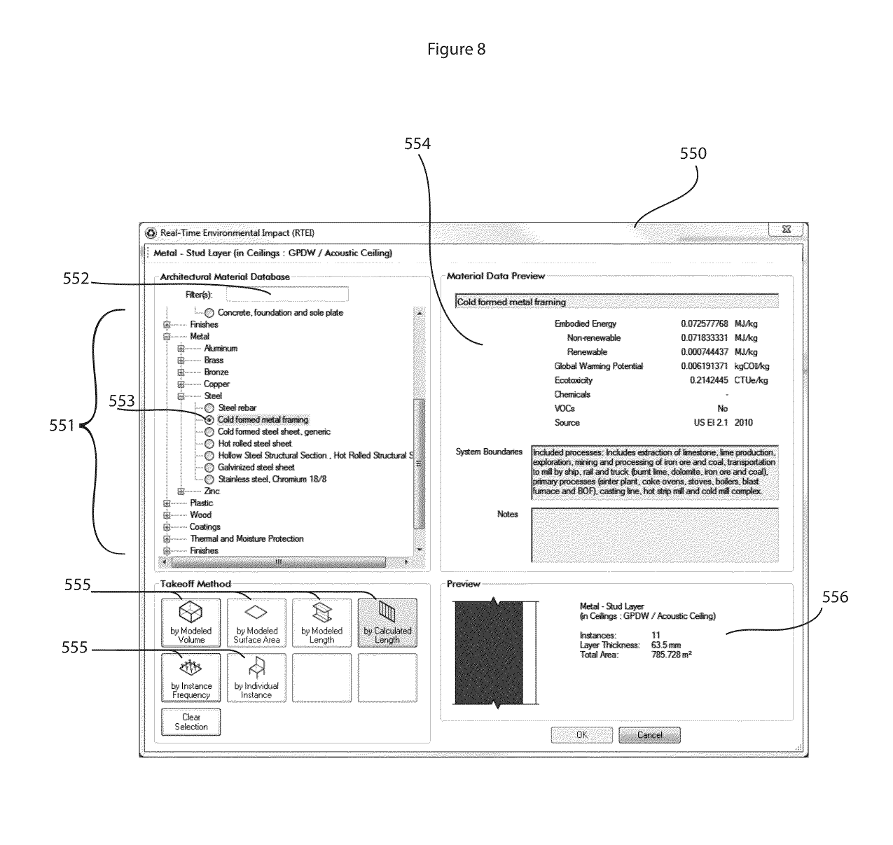

In a preferred embodiment of the invention, shown in FIG. 8, the operator selects a CAD model element and associates information with the CAD model element through a graphic user interface 550. The graphic user interface facilitates the selection of reference data 554 contained in the database, represented by the material list 551 made available to the operator. In an embodiment, the material list 551 facilitates filtering of database entries using search keywords 552. The material list portion of the graphic user interface 550 also facilitates the selection of a specific database entry 553, which corresponds to the step of providing reference data regarding CAD model elements. In an embodiment, the graphic user interface 550 also prompts the operator to provide a take-off method 555 from a list of standard options. In some embodiments, the individual database entry contains all such applicable take-off methods available to the user for the particular database entry and the graphic user interface makes the available take-off methods 555 visible to the operator. In a further embodiment, the graphic user interface 550 provides take-off data 556 for the referenced CAD model elements for which the operator is providing data 551, 553, and 555.

In a still further embodiment, the operator is prompted to select a take-off method 600 from a list of a plurality of standard take-off methods 555 within the graphic user interface 550. In a yet further embodiment, the operator is then prompted to enter specific physical element data 601; the types of physical element data the user is prompted to enter 601 depend on the take-off method 600 selected. In many embodiments, the physical element data provided 601 consists additional data not present in the CAD model element. Physical element data provided 601 by the operator is used to generate take-off formulas, which are stored in the CAD model. In an embodiment, the operator may choose to store the take-off formulas in the database or in the CAD model.

Without further elaboration the foregoing will so fully illustrate my invention that others may, by applying current or future knowledge, adopt the same for use under various conditions of service.

We claim:

1. A method for determining embodied environmental impact in a building design from a model, the method comprising the steps of:
generating in a computer-aided-design program a building model having CAD model elements;
providing reference data regarding physical elements;
generating a first take-off list based on said building model;
analyzing said first take-off list to find matches between said CAD model elements and said reference data;
modifying said first take-off list based on said reference data;
generating a second take-off list based on said first take-off list and said reference data; and
calculating embodied environmental impact from said second take-off list and said reference data.

2. The method of claim 1, wherein a first of said building CAD model elements is not a fully detailed model and wherein a first reference data dataset corresponding to said first building model component element includes details not included in said first building model component element.

3. The method of claim 1, wherein said reference data comprises information about a component including at least one of: embodied energy, density, embodied carbon, embodied water, synonymous names, and sources for material figures and calculations.

4. The method of claim 1, wherein said reference data comprises information about a component including at least one of: a material constant, a formula describing material utilization, a ratio of materials inside an assembly.

5. The method of claim 1, wherein said reference data resides in a database and wherein said database is updated when new or different component information than previously-stored component information is available.

6. The method of claim 1, wherein said first take-off list comprises component identifiers and component metrics.

7. The method of claim 6, wherein said first take-off list further comprises take-off method information regarding CAD modeling practice.

8. The method of claim 6, wherein said first take-off list further comprises take-off formulas, which represent functional relationships between modeled geometry and a physical material quantity of a building component.

9. The method of claim 1, wherein said modification of said first take-off list is performed by user initiation.

10. The method of claim 1, wherein said first take-off list is automatically generated each time said building model or component information changes.

11. The method of claim 1, wherein said reference data comprise formulas relating a quantity, area, length, volume or mass take-off to a material utilization constant.

12. A method for determining embodied environmental impact in a building design from a building model, the method comprising the steps of:
generating in a computer-aided-design program a building model having CAD model elements;
providing reference data regarding physical elements;
providing take-off methods representing CAD modeling practice;
providing data regarding take-off formulas;
generating a take-off list based on said building model;
calculating embodied environmental impact from said take-off list and said reference data and said formulas.

13. The method of claim 12, wherein said take-off list is automatically generated when changes are made to the building model.

14. A method for determining embodied environmental impact in a component element of a building model, the method comprising the steps of:
generating in a computer-aided-design program a representative geometry of the component element with corresponding take-off data;
choosing from a list of options a standard formula based on user CAD modeling practice;
providing reference data regarding physical elements;
and calculating the embodied environmental impact based on said take-off data, said chosen standard formula, and said reference data.

15. The method of claim 14, wherein said take-off data comprises a quantification of elements in a model in the units of volume, mass, length, area, or part count.

16. The method of claim 14, wherein said representative geometry is generated to be homogenous in material, when actual physical element is non-homogeneous in material.

17. The method of claim 14, wherein said take-off methods are relationships between embodied environmental impact quantities of components and take-off data.

18. The method of claim 17, wherein said take-off data comprise an area take-off, quantity, length, mass, or volume.

19. The method of claim 14, wherein said methods are stored in said list of options through a graphic user interface.

20. The method of claim 14, wherein said reference data comprises material descriptions, names, model numbers, bibliographic information, synonymous names, embodied energy quantity, embodied carbon, or density.

21. The method of claim 14, wherein said take-off formula comprises data provided by user regarding physical elements not present in the CAD model element based on CAD modeling practice.
